(19) United States
(12) Patent Application Publication
(10) Pub. No.: US 2011/0100659 A1
(43) Pub. Date: May 5, 2011

(54) PILE DRIVER

(75) Inventors: Tokuo Murate, Nagoya-shi (JP); Nobuyuki Tomida, Nagoya-shi (JP)

(73) Assignee: NIPPON SHARYO,LTD., Nagoya-shi, Acihi (JP)

(21) Appl. No.: 12/735,118

(22) PCT Filed: Jan. 7, 2008
(86) PCT No.: PCT/JP2008/050030

§ 371 Date: Jun. 17, 2010

(51) Int. Cl. B25D 16/00

(52) U.S. Cl. 173/104

(57) ABSTRACT

A pile driver enables angle adjustment and pile core adjustment of a leader to be performed easily, by minimizing an angle change of the leader when the pile core adjustment is performed. In the pile driver, an upper part of the leader is supported by a leader erect cylinder from behind, and a lower part of the leader is supported by a forward and backward adjustment means that includes a leader arm having a rotation base rotatably attached to a base machine and a rotation end rotatably attached to the lower part of the leader. A first arc traced by the rotation end when the leader arm is rotated to adjust the lower part of the leader forward and backward and a second arc traced by a connection part between the leader and a tip of the leader erect cylinder when the lower part of the leader is adjusted are both convex upward. The first arc has a smaller radius than the second arc. An end of the first arc and an end of the second arc when the lower part of the leader is adjusted farthest backward are each at a highest position. In addition, a straight line passing through both end points of the second arc is parallel to a tangent line at a center part of the first arc.

### TECHNICAL FIELD

The present invention relates to a pile driver, and in particular relates to a pile driver in which an upper part of a leader that is stood on a front part of a base machine is supported by a leader erect cylinder from behind and a lower part of the leader is supported by a forward and backward adjustment means so as to be adjustable forward and backward.

### BACKGROUND ART

As a pile driver, a pile driver in which an upper part of a leader that is stood on a front part of a base machine including a traveling section is supported by a leader erect cylinder from behind and a lower part of the leader is supported by a forward and backward adjustment means is known. In such a pile driver, pile core adjustment is performed by the forward and backward adjustment means, and angle adjustment is performed by the leader erect cylinder (for example, see Patent Document 1).

Patent Document 1: Japanese unexamined Patent Publication (Kokai) No. Hei 9-100534

### DISCLOSURE OF THE INVENTION

### Problems the Invention is to Solve

In the conventional pile driver, however, when the pile core adjustment is performed after the angle adjustment, the lower part of the leader moves forward and backward and as a result the angle of the leader changes. This makes it necessary to perform the angle adjustment of the leader again. In other words, to adjust the angle and the pile core of the leader, the pile core adjustment by the forward and backward adjustment means and the angle adjustment by the leader erect cylinder need to be repeated a plurality of times.

In view of this, an objective of the present invention is to provide a pile driver that enables angle adjustment and pile core adjustment of a leader to be performed easily, by minimizing an angle change of the leader when the pile core adjustment is performed.

### Means to Solve the Problems

A pile driver according to the present invention is a pile driver in which an upper part of a leader that is stood on a front part of a base machine is supported by a leader erect cylinder from behind and a lower part of the leader is supported by a forward and backward adjustment means. The forward and backward adjustment means includes a leader arm having a rotation base rotatably attached to the base machine and a rotation end rotatably attached to the lower part of the leader, and an arm driving means for rotating the leader arm about the rotation base. A first arc traced by the rotation end when the leader arm is rotated to adjust the lower part of the leader forward and backward and a second arc traced by a connection part between the leader and a tip of the leader erect cylinder which moves as the lower part of the leader moves forward and backward along the first arc are both convex upward. The first arc has a smaller radius than the second arc. An end of the first arc and an end of the second arc when the lower part of the leader is adjusted farthest backward are each at a highest position. In addition, a straight line passing through both end points of the second arc is parallel to a tangent line at a center part of the first arc.

Moreover, the leader is preferably in a vertical state at each of a front end position where the lower part of the leader is adjusted farthest forward and a back end position where the lower part of the leader is adjusted farthest backward.

### EFFECTS OF THE INVENTION

In the pile driver according to the present invention, it is possible to minimize the angle change of the leader when the pile core adjustment is performed by moving the lower part of the leader forward and backward. Therefore, even when the forward and backward adjustment for adjusting the pile core is performed, there is no need to perform the angle adjustment of the leader again.

### BRIEF DESCRIPTION OF THE DRAWINGS

FIG. 1 is a side view showing an embodiment of a pile driver according to the present invention.

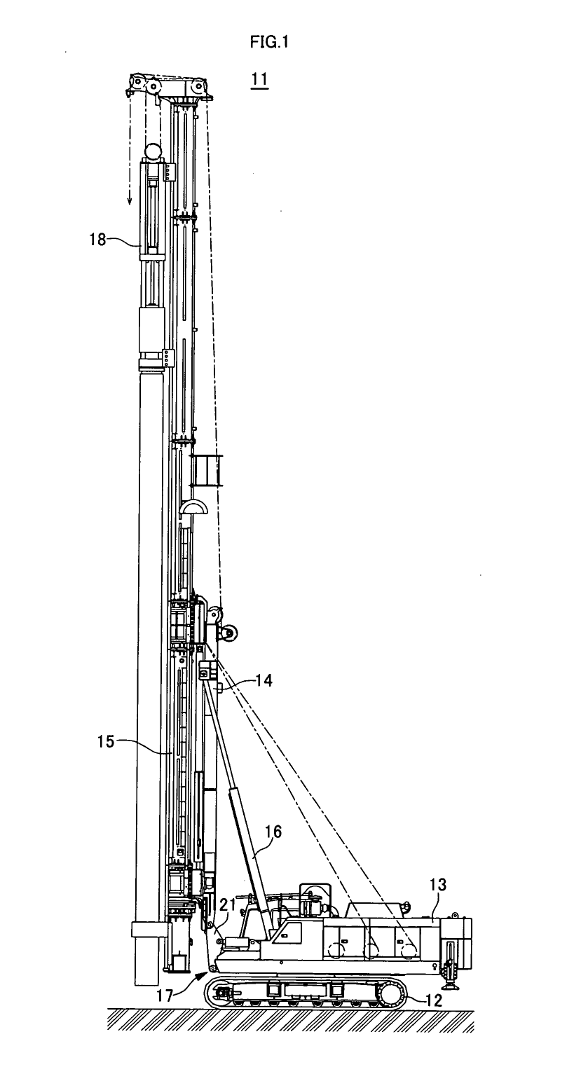

FIG. 2 is a side view of the relevant part showing a state where a lower part of a leader is moved farthest forward and the leader is at a vertical angle.

FIG. 3 is a side view of the relevant part showing a state where the lower part of the leader is adjusted to an intermediate position from the state of FIG. 2.

FIG. 4 is a side view of the relevant part showing a state where the lower part of the leader is adjusted farthest backward from the state of FIG. 3.

FIG. 5 is an explanatory view showing a relation between a first arc and a second arc from the state of FIG. 2 through to the state of FIG. 4.

FIG. 6 is a side view of the relevant part showing a state where the lower part of the leader is moved farthest forward and the leader is inclined forward at 3 degrees.

FIG. 7 is a side view of the relevant part showing a state where the lower part of the leader is adjusted to the intermediate position from the state of FIG. 6.

FIG. 8 is a side view of the relevant part showing a state where the lower part of the leader is adjusted farthest backward from the state of FIG. 7.

### BEST MODE FOR CARRYING OUT THE INVENTION

A pile driver 11 includes: a traveling section 12 having a crawler; a base machine 13 swingably mounted on the traveling section 12; a subleader 14 erectably provided at a front part of the base machine 13; a leader 15 provided via the subleader 14; one pair of left and right leader erect cylinders 16 supporting the subleader 14 from behind; and a leader support link 17 supporting a lower part of the subleader 14. A hydraulic unit for driving a working device 18 such as an auger attached to the leader 15 and driving a hydraulic motor or a hydraulic cylinder is provided at a back part of the base machine 13.

The leader support link 17 forms a forward and backward adjustment means for adjusting a position of a lower part of the leader 15 forward and backward via the subleader 14. The forward and backward adjustment means includes a leader arm 21 having a rotation base 19 rotatably attached to the front part of the base machine 13 and a rotation end 20 rotatably attached to the lower part of the subleader 14, and a hydraulic cylinder 22 that is an arm driving means for rotating the leader arm 21 about the rotation base 19.

Position adjustment of the leader 15 in a forward and backward direction, namely, pile core adjustment, is performed by extending and retracting the hydraulic cylinder 22 to rotate the leader arm 21 about the rotation base 19. When the hydraulic cylinder 22 is extended, the rotation end 20 of the leader arm 21 rotates forward, as a result of which the lower part of the leader 15 moves forward. When the hydraulic cylinder 22 is retracted, the lower part of the leader 15 moves backward toward the base machine 13. A width of the forward and backward adjustment of the lower part of the leader 15 is typically about 500 mm at the maximum.

Here, an axial attachment point P1 of the rotation end 20 of the leader arm 21 to the subleader 14 traces an arc (first arc A1) that is centered on an axial attachment point P2 of the rotation base 19 of the leader arm 21 to the base machine 13. This first arc A1 is convex upward, because the axial attachment point P2 of the leader arm 21 to the base machine 13, which serves as the center of the first arc A1, is located below the axial attachment point P1 of the leader arm 21 to the subleader 14.

Moreover, as the lower part of the subleader 14 moves forward and backward along the first arc A1, an axial attachment point P3 of the leader erect cylinders 16 to the subleader 14 also moves forward and backward along an arc (second arc A2) that is centered on an axial attachment point P4 of the leader erect cylinders 16 to the base machine 13. This second arc A2 is convex upward too, because the axial attachment point P4 of the leader erect cylinders 16 to the base machine 13, which serves as the center of the second arc A2, is located below the axial attachment point P3 of the leader erect cylinders 16 to the subleader 14.

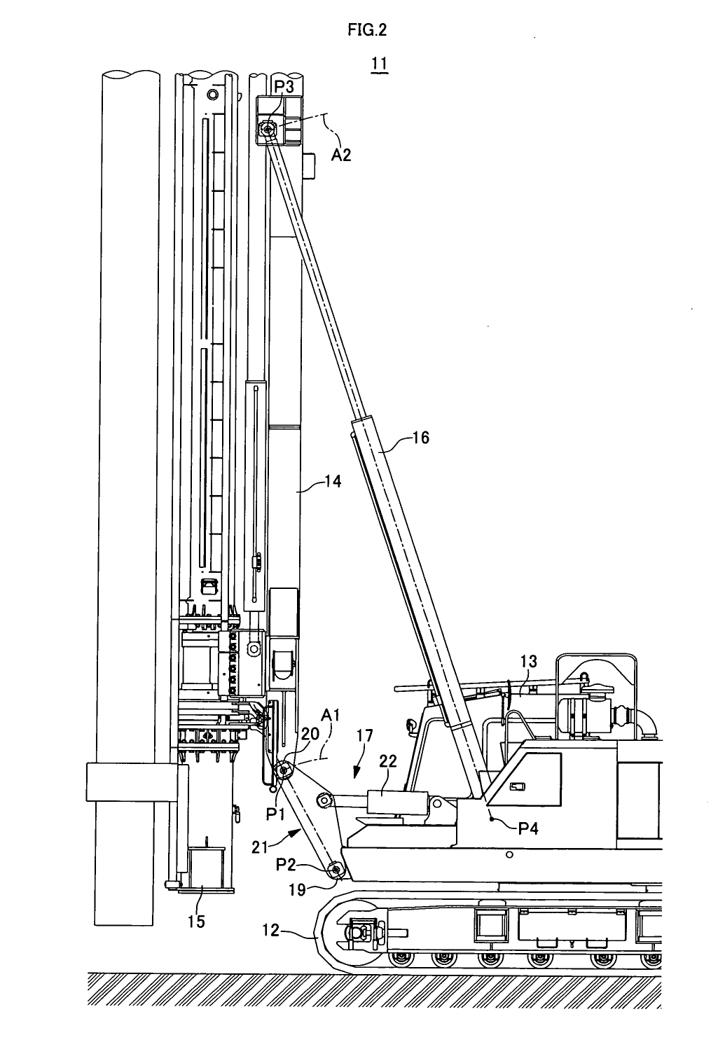

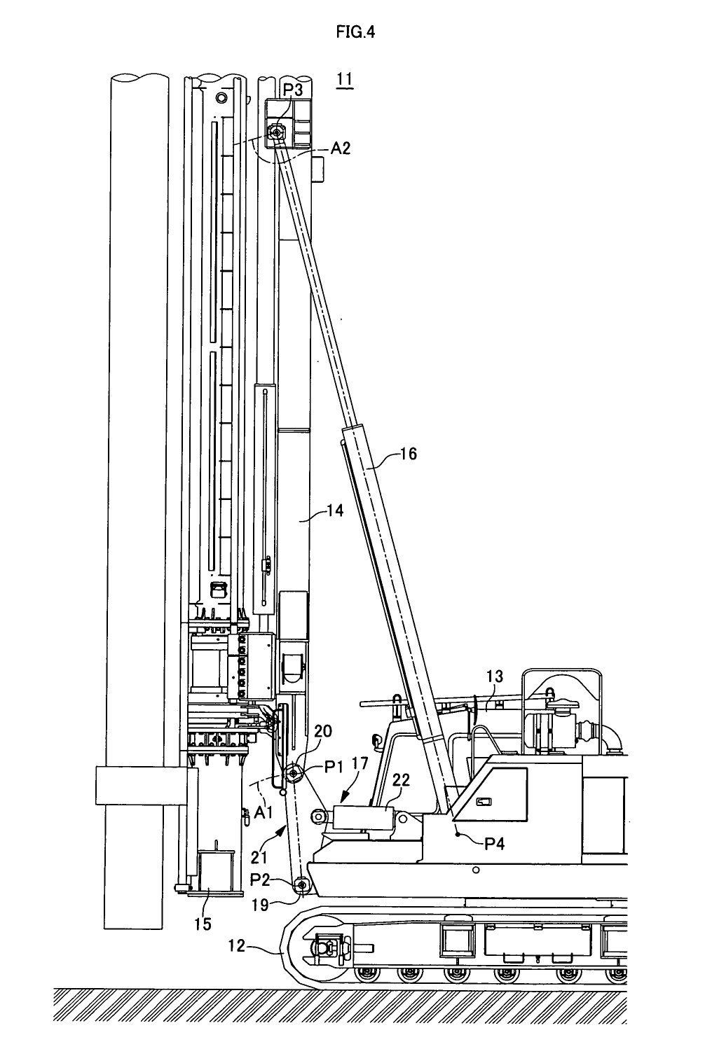

Furthermore, when the lower part of the leader 15 is adjusted farthest forward, the leader arm 21 is in a state where a straight line connecting the axial attachment points P1 and P2 of the leader arm 21 is inclined forward at about 45 degrees from a vertical line, as shown in FIG. 2. When the lower part of the leader 15 is adjusted farthest backward, the leader arm 21 is in a standing state where the straight line connecting the axial attachment points P1 and P2 of the leader arm 21 is slightly inclined forward from the vertical direction, as shown in FIG. 4. Since the axial attachment point P1 of the leader arm 21 to the subleader 14 is located forward of the axial attachment point P2 of the leader arm 21 to the base machine 13 in this standing position, the first arc A1 is at a highest position when the lower part of the leader 15 is adjusted farthest backward. The same applies to the leader erect cylinders 16. Since the axial attachment point P4 of the leader erect cylinders 16 to the base machine 13 is located backward of the axial attachment point P3 of the leader erect cylinders 16 to the subleader 14 when the lower part of the leader 15 moves farthest backward, the second arc A2 is at a highest position when the lower part of the leader 15 is adjusted farthest backward.

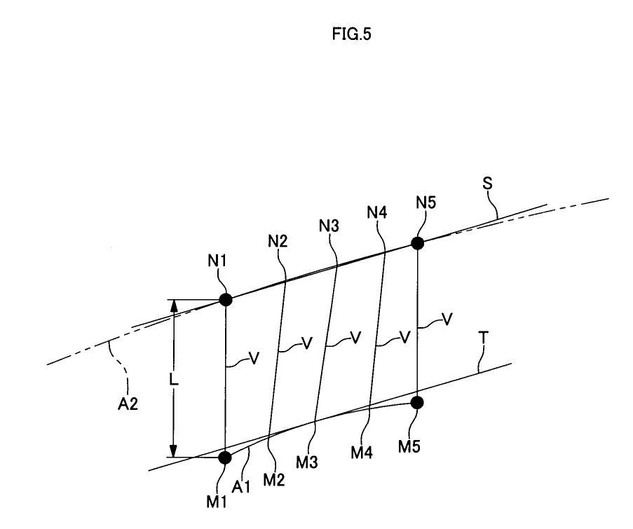

Which is to say, the positions of the axial attachment points P1, P2, P3, and P4 are set so that the first arc A1 and the second arc A2 have the relation shown in FIG. 5. The first arc A1 is an arc from a front end position M1 at which the lower part of the leader 15 is adjusted farthest forward, through intermediate positions M2, M3, and M4, to a back end position M5 at which the lower part of the leader 15 is adjusted farthest backward. The first arc A1 is convex upward, and is located highest at the back end position M5, as mentioned earlier. Likewise, the second arc A2 is an arc from a front end position N1 at which the lower part of the leader 15 is adjusted farthest forward, through intermediate positions N2, N3, and N4, to a back end position N5 at which the lower part of the leader 15 is adjusted farthest backward. The second arc A2 is convex upward, and is located highest at the back end position N5, as mentioned earlier. Moreover, an angle range from the front end position M1 to the back end position M5 of the first arc A1, namely, a rotation angle of the leader arm 21, is preferably in a range where the leader arm 21 is inclined forward about 45 degrees to about 85 degrees from the vertical line. When the leader arm 21 is inclined forward too much, there is a problem that the amount of movement of the lower part of the leader 15 becomes smaller relative to the rotation angle of the leader arm 21. When the leader arm 21 is closer to the vertical line, there is a problem that, even when the leader arm 21 is rotated, the leader erect cylinders 16 do not rotate almost at all and the axial attachment point P does not move on the second arc A2 almost at all.

Furthermore, the relation between the first arc A1 and the second arc A2 is set so that the first arc has a smaller radius than the second arc, and also a tangent line T at a center part of the first arc A1 (for example, a tangent line at the position M3) is parallel to a straight line S passing through the front end position N1 and the back end position N5 which are both end points of the second arc A2. This being so, when the front end positions or the back end positions of both arcs A1 and A2 are overlapped, for example when the front end positions M1 and N1 of both arcs A1 and A2 are overlapped, one of the following first, second, and third states is observed. In the first state, the first arc A1 moves away from the second arc upward from the front end position M1 or N1 to the intermediate positions of the arc, and then approaches the second arc from the intermediate positions of the arc to the back end position M5 or N5. In the second state, the first arc A1 moves away from the second arc upward at the intermediate positions of the arc, and then approaches the second arc and reaches the second arc. In the third state, the first arc A1 moves away from the second arc upward in a first half of the intermediate positions of the arc, approaches the second arc and reaches the second arc in a latter half of the intermediate positions of the arc, and then moves away from the second arc downward.

Suppose here that, as shown in FIG. 5, the relation between the first arc A1 and the second arc A2 is set so that a line segment V of a length L connecting the front end position M1 of the first arc A1 and the front end position N1 of the second arc A2 is vertical and also the line segment V of the same length L vertically connects the back end position M5 of the first arc A1 and the front end position N5 of the second arc A2. In this case, when the lower part of the leader 15 is adjusted forward and backward, a lower end of the line segment V travels along the first arc A1 and an upper end of the line segment V travels along the second arc A2.

When the lower end of the line segment V travels from the front end position M1 to the position M2 that is forward of the position M3 at which the tangent line T is parallel to the straight line S, the lower end of the line segment V moves diagonally backward and upward, where the line segment V is in such a state of being pushed up diagonally backward. Meanwhile, the upper end of the line segment V moves along the second arc A2 having the larger radius. Accordingly, the amount of rise of the upper end of the line segment V is smaller than the amount of rise of the lower end of the line segment V which moves along the first arc A1 having the smaller radius, so that the amount of backward movement increases with the difference in the amount of rise between the upper end and the lower end of the line segment V. Therefore, the upper end of the line segment V moves to the position N2 that is backward of the position M2, and the upper part of the line segment V is inclined backward.

Thus, when the lower end of the line segment V moves from the front end position M1 toward the back end position M5, until the lower end of the line segment V reaches the position M3 at which the tangent line T to the first arc A1 is parallel to the straight line S, the amount of rise of the upper end of the line segment V moving along the second arc A2 is smaller than the amount of rise of the lower end of the line segment V moving along the first arc A1, so that the backward inclination angle of the line segment V gradually increases. When the lower end of the line segment V reaches the position M3, the upper end of the line segment V reaches the position N3. The inclination angle of the line segment V is largest at this time.

After the lower end of the line segment V passes through the position M3, the line of the first arc A1 having the smaller radius becomes closer to a horizontal direction, while the line of the second arc A2 having the larger radius continues to rise in the same way as in the positions M1 to M3. Accordingly, the amount of rise of the upper end of the line segment V moving from the position N3 to the position N4 along the second arc A2 becomes larger than the amount of rise of the lower end of the line segment V moving from the position M3 to the position M4, so that the backward inclination angle of the line segment V gradually decreases. Lastly, when the lower end of the line segment V moves to the back end position M5, the upper end of the line segment V moves to the back end position N5, where the line segment V becomes vertical again.

Therefore, as a result of setting the positions of the axial attachment points P1, P2, P3, and P4 so that the relation between the first arc A1 and the second arc A2 satisfies the above conditions, when moving the lower part of the leader 15 from the front end position to the back end position, the leader 15 in the course of movement begins from the vertical state at the front end position, goes through the state where the upper end is slightly inclined backward, and returns to the vertical state again when the lower part of the leader 15 reaches the back end position. In particular, by setting a point of tangency of the tangent line T to the first arc A1 which is parallel to the straight line S to be located at or near a center of the forward and backward adjustment range of the leader 15 when the leader 15 is vertical, the first arc A1 and the second arc A2 can be made more similar to each other so as to have a substantially identical shape. As a result, the angle change during the movement of the line segment V can be further reduced.

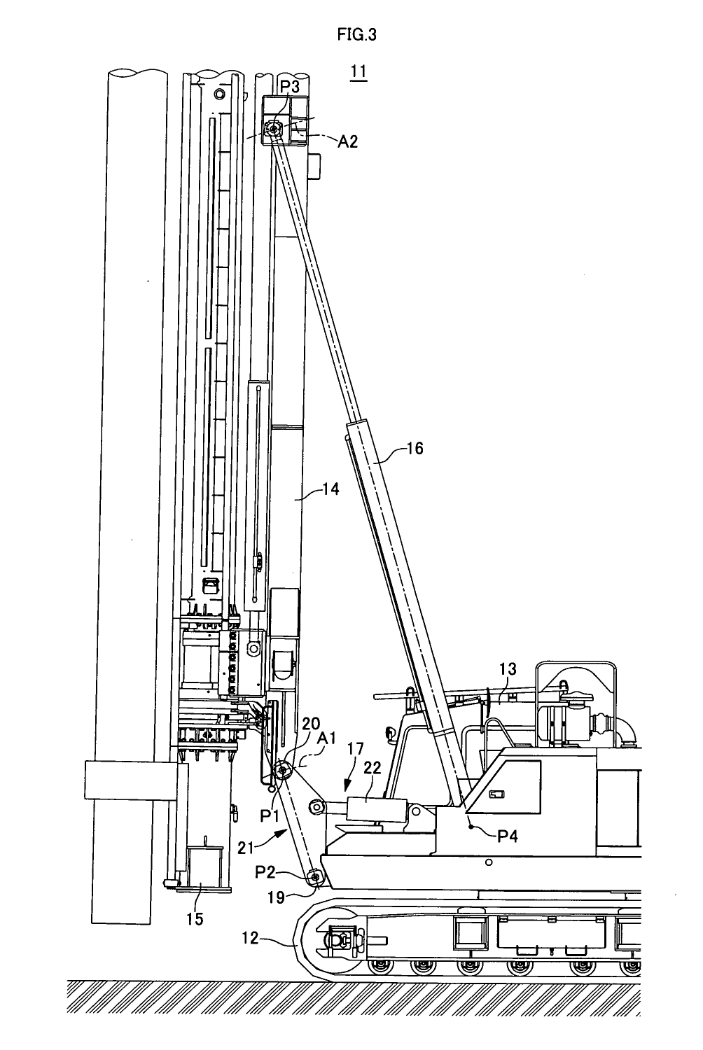

Thus, by appropriately setting the positions of the respective axial attachment points P2 and P4 of the leader arm 21 and the leader erect cylinders 16 to the base machine 13, the distance between the axial attachment points P1 and P2 of the leader arm 21 (the radius of the first arc A1), the rotation angle of the leader arm 21 (the forward and backward adjustment range of the leader 15), the length of the leader erect cylinders 16 (the radius of the second arc A2), and the positions of the respective axial attachment points P1 and P3 of the leader arm 21 and the leader erect cylinders 16 to the subleader 14 in the range where the relation between the first arc A1 and the second arc A2 satisfies the above conditions, it is possible to reduce the change of the inclination angle of the leader 15 in the state shown in FIG. 2 where the leader 15 is vertical at the front end position, in the state shown in FIG. 3 where the lower part of the leader 15 is moved backward to the intermediate position in the forward and backward adjustment range from the state shown in FIG. 2, and in the state where the lower part of the leader 15 is adjusted to the back end position. As an example, the change of the inclination angle can be reduced to 1 degree or less. In other words, it is possible to minimize the angle change of the leader 15 when the pile core adjustment is performed by driving the leader support link 17. Even when the pile core adjustment is performed by the leader support link 17 which is the forward and backward adjustment means, there is no need to perform the angle adjustment by the leader erect cylinders 16 again. Therefore, the angle adjustment and the pile core adjustment of the leader 15 can be performed easily.

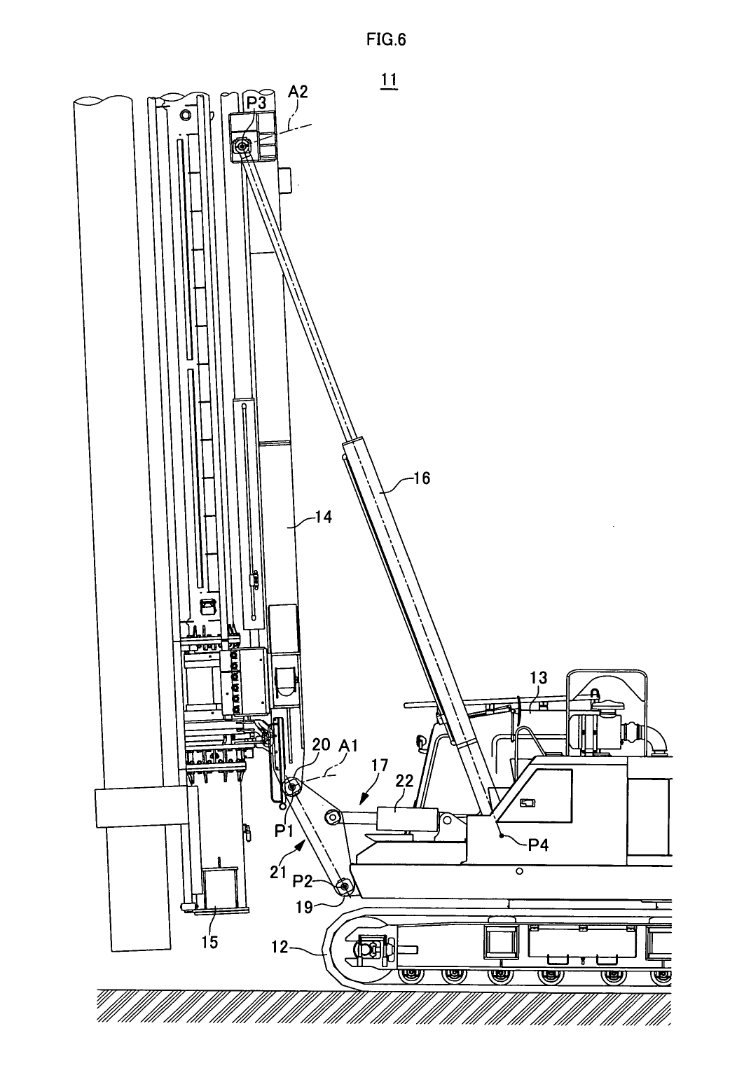

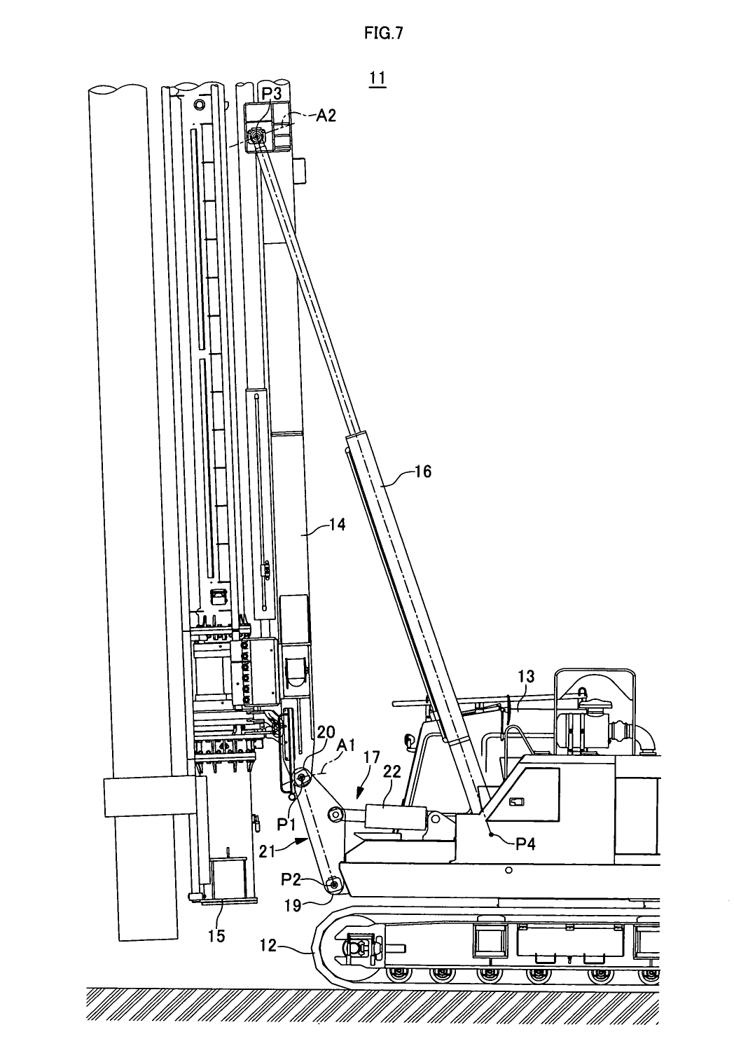

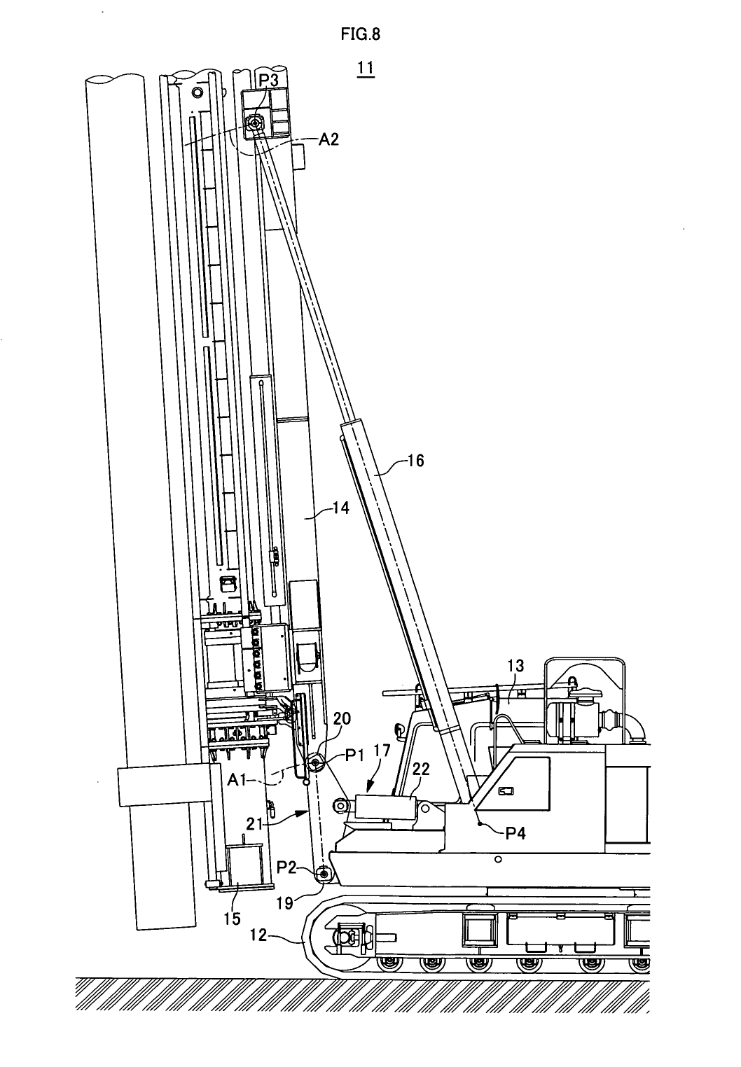

In addition, according to the settings described above, the angle change of the leader 15 is small even when, after the lower part of the leader 15 is moved farthest forward to a state where the leader 15 is inclined forward at a predetermined angle, for example inclined forward at 3 degrees as shown in FIG. 6, the pile core adjustment is performed by adjusting the lower part of the leader 15 to the intermediate position in the forward and backward adjustment range as shown in FIG. 7 and further adjusting the lower part of the leader 15 farthest backward as shown in FIG. 8. That is, even when the pile core adjustment is performed after the angle adjustment of making the leader 15 inclined forward at 3 degrees, there is almost no need to perform the angle adjustment by the leader erect cylinders 16 again.

This embodiment describes the pile driver in which the leader is provided via the subleader as an example, but the present invention is also applicable to a pile driver in which the leader erect cylinders are attached directly to the upper part of the leader or the leader arm is directly attached to the lower part of the leader.

1. A pile driver in which an upper part of a leader that is stood on a front part of a base machine is supported by a leader erect cylinder from behind and a lower part of the leader is supported by a forward and backward adjustment means,
wherein the forward and backward adjustment means comprises: a leader arm having a rotation base rotatably attached to the base machine and a rotation end rotatably attached to the lower part of the leader; and an arm driving means for rotating the leader arm about the rotation base,
a first arc traced by the rotation end when the leader arm is rotated to adjust the lower part of the leader forward and backward and a second arc traced by a connection part between the leader and a tip of the leader erect cylinder which moves as the lower part of the leader moves forward and backward along the first arc both being convex upward,
the first arc having a smaller radius than the second arc,
an end of the first arc and an end of the second arc when the lower part of the leader is adjusted farthest backward each being at a highest position, and
a straight line passing through both end points of the second arc being parallel to a tangent line at a center part of the first arc.

2. The pile driver according to claim 1, wherein the leader is in a vertical state at each of a front end position where the lower part of the leader is adjusted farthest forward and a back end position where the lower part of the leader is adjusted farthest backward.
